(19) United States
(12) Patent Application Publication
(10) Pub. No.: US 2008/0038115 A1
(43) Pub. Date: Feb. 14, 2008

(54) Spinning Disc Reactor with Shroud or Plate for Improving Gas/Liquid Contact

(75) Inventors: John Robert Burns, Sunderland (GB); Ian Henderson, Middlesbrough (GB)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignee: PROTENSIVE LIMITED, Cambridge (GB)

(21) Appl. No.: 11/572,392

(22) PCT Filed: Jul. 18, 2005
(86) PCT No.: PCT/GB05/02825

§ 371 Date: Jan. 19, 2007

(30) Foreign Application Priority Data
Jul. 19, 2004 (GB) 0416044.6

(51) Int. Cl. F03B 11/02

(52) U.S. Cl. 415/213.1

(57) ABSTRACT

A reactor apparatus including a support element rotatable about an axis (1) and having a surface (2) generally centred on the axis. The surface (2) is adapted for outward flow of a thin film of a liquid phase reactant thereacross when supplied thereto as the surface (2) is rotated. The reactor apparatus is further provided with a plate or shroud (10) that covers or is coextensive with the surface (2) and defines a gap (14) between the surface and an underside of the plate or shroud (10) so as to allow a gaseous phase flow through the gap (14) and over the thin film of the liquid phase reactant. By constraining the gaseous phase flow over the liquid phase component, especially when the gaseous phase flow is countercurrent to the liquid phase flow, excellent mass transfer between the two phases can be achieved.

The present invention relates to a rotating surface of revolution reactor or spinning disc reactor for mass and heat transfer applications, and in particular to such a reactor provided with a shroud or plate over its reaction surface for encouraging gas/liquid contact.

Rotating reactors or spinning disc reactors (SDRs) for mass and heat transfer applications are known from the present applicant's International patent applications WO00/48731, WO00/48729, WO00/48732, WO00/48730 and WO00/48728, the full contents of which are hereby incorporated into the present application by reference. Rotating reactors generally comprise a rotating or spinning surface, for example a disc or a cone, onto which one or more liquid reactants are supplied. Centrifugal forces cause the reactants to pass outwardly across the surface (i.e. centrifugal acceleration is aligned with a surface radius vector) in the form of a thin, generally wavy film, the film then being thrown from a circumference of the surface for collection. High turbulence and shear stresses in the film cause excellent mixing and mass transfer, and the low thickness of the film allows for excellent heat transfer to and from the film. It is to be appreciated that the generation of a thin, generally wavy and radially outwardly-moving film of reactant on the spinning surface is a key feature of SDR technology, including the present invention.

There are a number of commercially important applications of SDRs where it is necessary to ensure exceptionally effective contact between liquid and gaseous reactants. For example, in the area of polyesterification, a volatile gaseous reaction product (e.g. glycol or water vapour) must be removed very effectively if high conversions and low acid numbers are to be achieved. Furthermore, in the field of polymer devolatilisation, it is important to ensure that a liquid polymer passing across the surface of the SDR is contacted countercurrently with a stripping gas so as to achieve as low as possible a concentration of volatile components, e.g. unreacted monomer components, in the finished polymer product.

Existing SDR designs such as those identified above simply comprise a machine case in which the disc rotates. The stripping or reactant gas is supplied to a gas space above the disc and is removed by way of a central duct. Since the gas phase is very well mixed by virtue of the swirling action generated by the spinning disc, this prevents the liquid discharged from a periphery of the disc from being exposed to absolutely fresh gaseous feed.

In many cases, it is expected that mass transfer between the liquid film on the disc and the adjacent gas phase will be dominated by the fluid dynamic environment within the film (i.e. liquid film limitation). However, there may be instances where gas phase turbulence exerts a significant effect on the overall mass transfer rate, for example when highly soluble gaseous components are involved. In such cases, it is worth considering techniques for enhancing the shear stress generated at the gas-liquid interface.

It is known, for example from WO 00/48732, to provide an SDR with a rotary impeller or fan mounted above the rotating surface, the rotary impeller or fan serving to promote countercurrent gaseous flow over the reactant on the rotating surface. This solution, although effective, is mechanically complex and relatively expensive in its implementation. Furthermore, the rotary impeller or fan does not allow a radial velocity profile of the gaseous flow to be effectively controlled. It is to be noted that the rotary impeller or fan rotates independently of the SDR.

It is also known, for example from U.S. Pat. No. 2,507,490, to provide a bowl-shaped SDR provided with a correspondingly-shaped plate member mounted a constant distance above the rotating surface of the bowl-shaped SDR. The plate member is mounted so as to rotate with and at the same speed as the rotating surface. The separation between the plate and the rotating surface is constant across the radius of the SDR and is not adjustable. During operation, a liquid film is caused to flow outwardly across the rotating surface together with a gaseous reactant.

U.S. Pat. No. 4,549,998 discloses a rotating reactor comprising a stack of co-rotating plates. A liquid reactant is caused to flow outwardly across each plate, and a gaseous reactant is caused to flow inwardly between the plates. Again, the separation between the plates is fixed and constant, and the plates all rotate together.

According to a first aspect of the present invention, there is provided a reactor apparatus including a support element rotatable about an axis and having a surface generally centred on the axis, the surface being adapted for outward flow of a thin film of a liquid phase reactant thereacross when supplied thereto as the surface is rotated, the reactor apparatus being further provided with a stationary plate or shroud that covers or is coextensive with the surface and defines a gap between the surface and an underside of the plate or shroud so as to allow a gaseous phase flow through the gap and over the thin film of the liquid phase reactant.

Generally, the thin film will be in the form of a thin wavy film, the waves being important for enhanced mass transfer and shear within the film. The waves are not generated as a result of vibration, but are generally inherent in SDR applications where a thin film passes across a rotating surface.

By providing a stationary plate or shroud, advantageously generally centred on the axis, the reactor of the present invention is considerably simpler than the reactor of WO 00/48732 with its rotary fan or impeller. In particular, because the plate or shroud is stationary and can thus be firmly held or fixed in place, engineering tolerances need not be so high, since no consideration need be made of eccentric rotation or wobbles, as is the case in WO 00/48732 where the rotary impeller itself is rotated. It is to be appreciated that many applications of the present invention require very high engineering tolerances in the dimensions of the gap, especially in order to generate precise velocity profiles, and this is not easily achieved with a rotary fan or impeller. Moreover, the greater the diameter of the support element and hence the diameter of the stationary plate or shroud, the higher the engineering tolerances needed, especially at perimetral regions thereof where the gap may be very thin.

Use of a stationary plate or shroud that does not rotate with the support element serves to define a gas flow path over the thin liquid film so as to enhance mass transfer to or from the liquid film. Of particular advantage is that high shear stresses are applied to the gas as a result of the plate or shroud being stationary with respect to the support element. This is because the radial gas velocity component is generally lower than the local speed of rotation (i.e. the tangential velocity component), leading to increased gas shear and mass transfer coefficient.

Where the reactor apparatus is contained within a housing, the stationary plate or shroud may be clamped or otherwise affixed, possibly by way or struts or other supports, to parts of the housing, thus holding the stationary plate or shroud firmly in position over the support element so as to maintain the gap profile to a high tolerance.

The thinner the gap, the less the volume of the gaseous phase component required for devolatilisation or other purposes, since the gaseous phase component can be constrained close to the liquid phase component.

A surface of the plate or shroud that faces the surface of the support element may be generally parallel to the surface of the support element. Where the support element is formed as a disc with a flat surface, the surface of the plate or shroud will also be flat. Where the support element and its surface is conical or some other shape, the surface of the plate or shroud will have a complementary shape.

Preferably, however, the plate or shroud and/or the support element is configured such that the gap therebetween is not constant along a radius taken from the axis. In a particularly preferred embodiment, the gap between the plate or shroud and the support element increases towards the axis. This helps to avoid unacceptable gas pressure drops within the gap by allowing a roughly constant gas flow area to be defined between the plate to shroud and the support element as the gas flows inwardly towards the axis, and thereby avoiding possible choking of the gas flow. It is also advantageous for the gap to be continuously adjustable so as to control the gas flow and pressure drop, especially during operation of the reactor. This is discussed further in relation to the second aspect of the invention, the discussions in relation to the second aspect applying equally to the first aspect.

Preferably, the reactor is configured such that the gaseous phase flow is countercurrent to the liquid phase flow, since this provides for the best cross-transfer from the liquid phase to the gaseous phase, although in some embodiments the flows may be cocurrent.

In particularly preferred embodiments, a central part of the plate or shroud not facing the surface is provided with an aperture to which a pipe or conduit can be connected. A vacuum or partial vacuum may be applied through the pipe or conduit so as to suck the gaseous phase component from a circumferential edge region of the surface in a direction countercurrent to the flow of the liquid phase, or an overpressure of gaseous phase component may be supplied to a housing or machine casing in which the support element is contained. Alternatively, the gaseous phase may be pumped through the pipe or conduit for cocurrent flow. In these embodiments, the reactor apparatus may be contained within an airtight housing or machine casing to which the gaseous phase is supplied (for countercurrent flow), or which serves to collect the gaseous phase after passage through the gap (for cocurrent flow).

According to a second aspect of the present invention, there is provided a reactor apparatus including a support element rotatable about an axis and having a surface generally centred on the axis, the surface being adapted for outward flow of a thin film of a liquid phase reactant thereacross when supplied thereto as the surface is rotated, the reactor apparatus being further provided with a plate or shroud that covers or is coextensive with the surface and defines a gap between the surface and an underside of the plate or shroud so as to allow a gaseous phase flow through the gap and over the thin film of the liquid phase reactant, wherein the plate or shroud is rigidly affixed to the support element so as to rotate therewith, and wherein the gap has a width that varies with radial distance from the axis.

The plate or shroud may be affixed to the surface of the support element by way of connecting struts or the like, for example spaced around a perimeter of the surface. Alternatively or in addition, the plate or shroud may be affixed to an axle forming part of the support element and comprising the axis. In this latter embodiment, the plate or shroud may be releasably affixed to the axis so that a width of the gap can be adjusted (generally when the reactor is not in operation). In both variations, the key feature is that the plate or shroud and the support element together form a mechanically sound structure and do not move, wobble or distort relative to each other during operation of the reactor. This maintains the high engineering tolerances that are advantageous in the present invention.

Advantageously, a surface of the plate or shroud that faces the surface of the support element may be curved relative to the surface of the support element, for example having a trumpet or funnel shape, thus defining a gap that tapers towards the circumferential edge of the surface of the support element. In this way, the radial velocity of the gaseous phase relative to the liquid phase can be kept substantially constant by making the width of the gap inversely proportional to the radial distance from the axis (in other words, the shape of the curve will be of the 1/r type). By keeping the velocity of the gaseous phase component substantially constant, it is possible to reduce unwanted pressure drops. Furthermore, it is possible to avoid high gaseous phase velocities from pulling the liquid phase film away from the surface of the support element. Even where a substantially constant velocity is not critical, the use of a tapered gap, for example by using a conical rather than a trumpet-shaped plate or shroud, can still serve to slow the speed of the gaseous phase towards the axis.

Alternatively, the facing surface of the plate or shroud may be configured so that the width of the gap tapers towards the axis, thereby providing a significant acceleration of the gaseous phase flow towards the axis when the reactor is used for countercurrent flow.

Alternatively, the facing surface of the plate or shroud may be formed with a profile such that the width of the gap varies so as to achieve an increasing or decreasing velocity profile, or a customised velocity profile where the velocity increases and decreases at predetermined points along the radial distance.

The plate or shroud may be configured so as to be displaceable along the axis so as to vary the width of the gap as required for different applications. Generally speaking, the plate or shroud will be affixed at a chosen displacement while the reactor is in operation, although in some modes of operation, the plate or shroud may be displaced so as to adjust the gap while the reactor is running.

The facing surface of the plate or shroud may be smooth, or may alternatively be provided with a surface texture, fins, ribs, vanes, pins, projections, concentric or spiral grooves or the like so as to enhance or modify the flow profile of the gaseous phase, for example by enhancing turbulence (especially in embodiments where the support element rotates relative to the plate or shroud). However, in all embodiments, it is important that the facing surface of the plate or shroud does not actually contact the thin film of liquid phase reactant as it moves across the surface of the support element, but instead defines a gap between the film and the facing surface through which the gaseous phase may pass.

In preferred embodiments, the diameter of the surface of the support element may be from 5 cm to 2 m, preferably 10 cm to 1 m.

The diameter of the plate or shroud may be substantially the same as that of the surface of the support element. Alternatively, the diameter of the plate or shroud may be slightly smaller so as to allow access to the thin film at peripheral parts of the surface of the support element, for example in order to enable UV or other treatment of the liquid phase reactant before it is thrown from the periphery of the surface.

The peripheral width of the gap between the plate or shroud and the surface of the support element may in some embodiments be from 0.5 mm to 5 cm, or from 1 mm to 1 cm.

It is to be appreciated that these dimensions are given merely as examples for reactors that have been tested by the applicant.

The plate or shroud can be made of a metallic material, although in some applications polymeric or other thermally insulating materials may be used so as to reduce heat losses and condensation. Generally, the temperature of operation of the reactor will be quite high, and the materials used in the reactor should be able to withstand high temperatures, for example above 100° C. In some embodiments, at least the facing surface of the plate or shroud may comprise or be coated or otherwise provided with a catalytic material.

For a better understanding of the present invention and to show how it may be carried into effect, reference shall now be made by way of example to the accompanying drawings, in which:

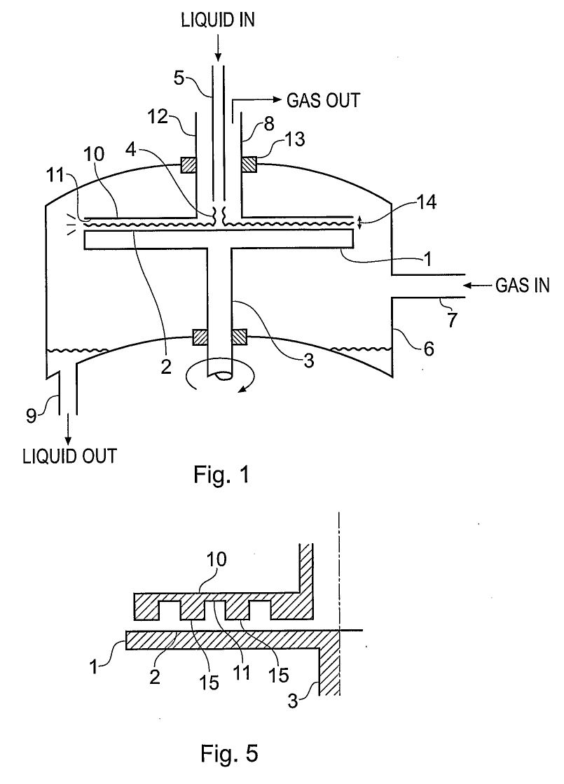

FIG. 1 shows a cross sectional view of a first embodiment of the present invention;

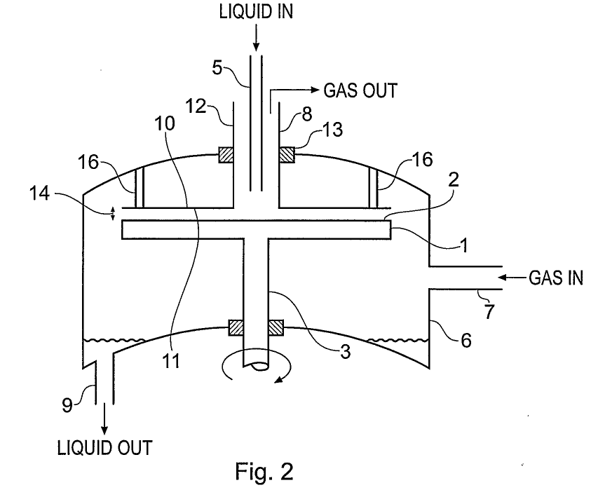

FIG. 2 shows a cross sectional view of a second embodiment of the present invention;

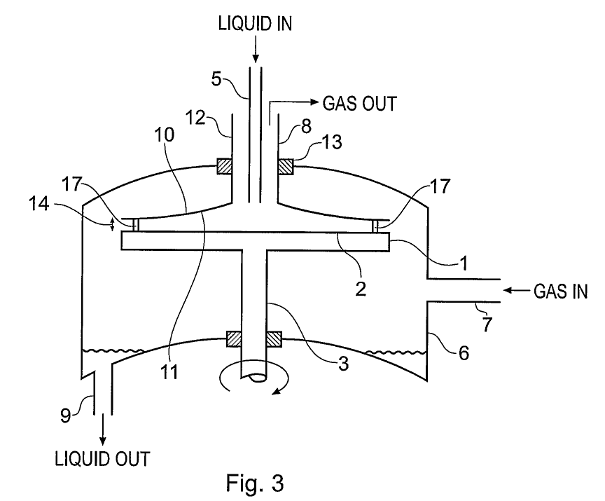

FIG. 3 shows a cross sectional view of a third embodiment of the present invention;

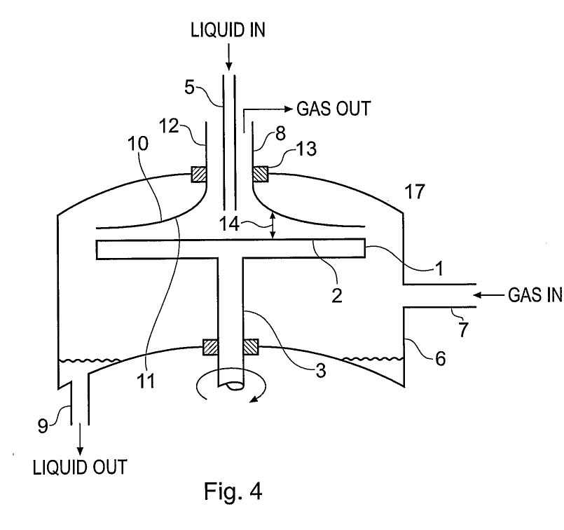

FIG. 4 shows a cross sectional view of a fourth embodiment of the present invention; and

FIG. 5 shows a detail of an embodiment where the shroud or plate has a ribbed underside.

FIG. 1 shows a reactor apparatus comprising a disc-shaped support element 1 with a surface 2. The support element 1 is axially mounted on a drive shaft 3 by means of which the support element 1 can be rotated at high speed. The support element 1 is contained within a sealed housing 6, which has an inlet 7 and an outlet 8 for a gas phase component. A liquid phase reactant 4 is supplied to a central part of the surface 2 by way of a feed 5. The reactant 4 travels radially and outwardly across the surface 2 as a thin wavy film before being thrown from a periphery of the surface 2. After it has travelled across the surface 2 and been thrown therefrom, the reactant 4 collects at a bottom of the housing 6 and can be removed therefrom by way of outlet 9.

A stationary shroud or plate 10 is mounted just above the surface 2 in such a way that it does not contact the thin wavy film. The shroud or plate 10 has a diameter similar to that of the support element 1, and has a lower surface 11 generally parallel to the surface 2. The shroud or plate 10 is mounted by way of a central axial tube 12 that is coaxial with the feed 5, and which is gripped at a top of the housing 6 by way of connector 13 that allows the shroud or plate 10 to be raised or lowered relative to the surface 2, thus defining a gap 14 between the surfaces 2 and 11.

During operation of the reactor apparatus, the gas phase component is supplied through the inlet 7 and removed from the outlet 8. The gas phase component may be supplied under pressure through the inlet 7, or removed under negative pressure from outlet 8, or both. The shroud or plate 10 ensures that there is excellent countercurrent flow of the gas phase component relative to the thin wavy film of liquid phase reactant 4 in the gap 14. The gas phase component may be used to devolatilise monomer components from a polymerisation reaction taking place in the thin way film, or may be used as a component of a chemical reaction. The nature of the chemistry performed by the reactor of the present invention is not particularly important in the context of the present application.

In embodiments where co-current flow is required, it will be appreciated that the inlet 7 and outlet 8 need simply be transposed.

FIG. 2 shows an alternative embodiment, with like parts being labelled as in FIG. 1. In this embodiment, the shroud or plate 10 is provided with supporting struts 16 that connect the shroud or plate 10 to an upper part of the housing 6. These supporting struts 16 help to provide structural integrity and ensure that the width of the gap 14 is maintained within very fine engineering tolerances.

FIG. 3 shows another alternative embodiment, in which the shroud or plate 10 is provided with supporting struts 17 that connect the shroud or plate 10 to the surface 2 of the support element 1. In this embodiment, the shroud or plate 10 is not stationary, but rotates with the support element 1. The central axial tube 12 is not gripped firmly by the connector 13, but is allowed to rotate relative thereto. The shroud or plate 10 is curved so that the gap 14 increases in width towards the axis defined by the drive shaft 3.

FIG. 4 shows a further alternative in which the shroud or plate 10 has a trumpet-shaped tapered profile, with the gap 14 being narrower at a periphery of the support element 1 than at its centre. The tapered profile has a 1/r shape so as to provide a substantially constant radial flow velocity for the gas phase component in the gap 14.

FIG. 5 shows a close-up cross-section through an alternative embodiment of the shroud or plate 10. Instead of the lower surface 11 being generally smooth, as in FIG. 1, the lower surface 11 in FIG. 2 is provided with concentric ribs or projections 15. The ribs or projections 15 serve to enhance turbulence in the gas phase component when it passes through the gap 14.

The preferred features of the invention are applicable to all aspects of the invention and may be used in any possible combination.

Throughout the description and claims of this specification, the words “comprise” and “contain” and variations of the words, for example “comprising” and “comprises”, mean “including but not limited to”, and are not intended to (and do not) exclude other components, integers, moieties, additives or steps.

1. A reactor apparatus including a support element rotatable about an axis and having a surface generally centred on the axis, the surface being adapted for outward flow of a thin film of a liquid phase reactant thereacross when supplied thereto as the surface is rotated, the reactor apparatus being further provided with a stationary plate or shroud that covers or is coextensive with the surface and defines a gap between the surface and an underside of the plate or shroud so as to allow a gaseous phase flow through the gap and over the thin film of the liquid phase reactant.

2. An apparatus as claimed in claim 1, further including a sealed housing in which the support element and the shroud or plate are contained, and having an inlet and an outlet for a gas phase component.

3. An apparatus as claimed in claim 2, wherein the shroud or plate is secured to the housing by struts or props or other means.

4. An apparatus as claimed in claim 1, wherein the shroud or plate is adjustable along the axis so as to allow a width of the gap to be varied.

5. An apparatus as claimed in claim 4, wherein the shroud or plate is configured to be adjustable during operation of the reactor.

6. A reactor apparatus including a support element rotatable about an axis and having a surface generally centred on the axis, the surface being adapted for outward flow of a thin film of a liquid phase reactant thereacross when supplied thereto as the surface is rotated, the reactor apparatus being further provided with a plate or shroud that covers or is coextensive with the surface and defines a gap between the surface and an underside of the plate or shroud so as to allow a gaseous phase flow through the gap and over the thin film of the liquid phase reactant, wherein the plate or shroud is rigidly affixed to the support element so as to rotate therewith, and wherein the gap has a width that varies with radial distance from the axis.

7. An apparatus as claimed in claim 6, further including a sealed housing in which the support element and the shroud or plate are contained, and having an inlet and an outlet for a gas phase component.

8. An apparatus as claimed in claim 6, wherein the shroud or plate is affixed to the surface of the support element by way of connecting struts or the like.

9. An apparatus as claimed in claim 6, wherein the shroud or plate is affixed to an axle defining the axis about which the support element rotates.

10. An apparatus as claimed in claim 9, wherein the shroud or plate is releasably affixed to the axle so that it can be affixed at different points along the axle, thus allowing a width of the gap to be varied.

11. An apparatus as claimed in claim 9, wherein the shroud or plate is affixed to the axle so as to be displaceable therealong during operation of the reactor.

12. An apparatus as claimed in claim 1, wherein a surface of the shroud or plate that faces the surface of the support element is generally parallel to the surface of the support element, and wherein the gap has a substantially constant width along a radius taken from the axis.

13. An apparatus as claimed in claim 1, wherein a surface of the shroud or plate that faces the surface of the support element is curved or inclined relative to the surface of the support element, and wherein the gap has a width that varies along a radius taken from the axis.

14. An apparatus as claimed in claim 13, wherein the facing surface of the shroud or plate has a trumpet-shaped configuration, the gap being narrowest at a periphery of the surface of the support element.

15. An apparatus as claimed in claim 14, wherein the facing surface of the shroud or plate is shaped such that the width of the gap is inversely proportional to a radial distance from the axis.

16. An apparatus as claimed in claim 13, wherein the facing surface of the shroud or plate has a conical configuration.

17. An apparatus as claimed in claim 13, wherein the width of the gap tapers towards a periphery of the surface of the support element.

18. An apparatus as claimed in claim 13, wherein the width of the gap tapers towards the axis.

19. An apparatus as claimed in claim 13, wherein the width of the gap alternately increases and decreases or decreases and increases along the radius taken from the axis.

20. An apparatus as claimed in claim 1, wherein the shroud or plate is provided with a surface texture, fins, ribs, vanes, pins, projections, concentric or spiral grooves or other discontinuities so as to modify a flow profile of the gaseous phase flow in the gap.

21. An apparatus as claimed in claim 1, wherein the shroud or plate is coated with or provided with or made of a catalytic material.

22. An apparatus as claimed in claim 1, wherein the shroud or plate is made out of a metallic material.

23. An apparatus as claimed in claim 1, wherein the shroud or plate is made out of a thermally insulating material, for example a polymeric material.

24. (canceled)
